(19) United States
(12) Patent Application Publication
(10) Pub. No.: US 2017/0302429 A1
(43) Pub. Date: Oct. 19, 2017

(54) DUPLEXING AND COMBINING NETWORKS

(71) Applicant: Andrew Wireless Systems GmbH, Buchdorf (DE)

(72) Inventors: Samuele Brighenti, Faenza (RA) (IT); Massimiliano Mini, Forli (IT)

(21) Appl. No.: 15/482,408

(22) Filed: Apr. 7, 2017

Related U.S. Application Data
(60) Provisional application No. 62/323,077, filed on Apr. 15, 2016.

(51) Int. Cl. H04L 5/14; H04B 1/00

(52) U.S. Cl. CPC H04L 5/1461; H04B 1/0057

(57) ABSTRACT

Duplexing and combining networks are provided. In one embodiment, a duplexing network for combining two signals comprises: a first port; a second port; a third port; a first hybrid coupler coupled to the first port; a second hybrid coupler coupled to the second port; a third hybrid coupler coupled to the third port; wherein the first, second, and third hybrid couplers are each four-port quadrature hybrid couplers; wherein the first hybrid splits a first signal received at the first port between a first diplexer and a second diplexer; wherein the second hybrid splits a second signal received at the first port between the first diplexer and the second diplexer; the third hybrid receives a first composite signal from the first diplexer and a second composite signal from the second diplexer and constructively sums the first composite signal and the second composite signal to produce an output at the third port.

### CROSS-REFERENCE TO RELATED APPLICATIONS

This Application claims the benefit of, and priority to, U.S. Provisional Patent Application No. 62/323,077, titled “DUPLEXING AND COMBINING NETWORKS”, filed on Apr. 15, 2016 and which is incorporated here in its entirety.

### BACKGROUND

Ceramic filters that are used in present day radio frequency (RF) signal duplexers are limited with respect to their capability to provide signal path isolation and RF power handling. In addition many contemporary RF signal transport systems are expected to be able to transmit and receive over multiple frequency bands. Combining multiple different frequency bands can lead to problems of insertion loss. Furthermore a degree of modularity of the combining network is desirable.

### SUMMARY

In one embodiment, a duplexing network for combining two signals comprises: a first port; a second port; a third port; a first hybrid coupler coupled to the first port; a second hybrid coupler coupled to the second port; a third hybrid coupler coupled to the third port; wherein the first hybrid coupler, the second hybrid coupler and the third hybrid coupler are each four-port quadrature hybrid couplers; wherein the first hybrid splits a first signal received at the first port between a first diplexer and a second diplexer; wherein the second hybrid splits a second signal received at the first port between the first diplexer and the second diplexer; wherein the third hybrid receives a first composite signal from the first diplexer and a second composite signal from the second diplexer and constructively sums the first composite signal and the second composite signal to produce an output at the third port.

### DRAWINGS

Embodiments of the present disclosure can be more easily understood and further advantages and uses thereof more readily apparent, when considered in view of the description of the preferred embodiments and the following figures in which:

FIG. 1 is a diagram illustrating a duplexing network of one embodiment of the present disclosure;

FIGS. 2, 2A, 2B, 2C and 2D are diagrams illustrating a duplexing and combining network of one embodiment of the present disclosure;

FIG. 3 is a diagram illustrating another duplexing and combining network of one embodiment of the present disclosure;

FIG. 4 is a diagram of a C-RAN architecture system utilizing at least one duplexing network or duplexing and combining network of one embodiment of the present disclosure; and

FIG. 5 is a diagram of a distributed antenna system utilizing at least one duplexing network or duplexing and combining network of one embodiment of the present disclosure.

### DETAILED DESCRIPTION

In the following detailed description, reference is made to the accompanying drawings that form a part hereof, and in which is shown by way of specific illustrative examples in which the embodiments may be practiced. These embodiments are described in sufficient detail to enable those skilled in the art to practice the embodiments described herein, and it is to be understood that other embodiments may be utilized and that logical, mechanical and electrical changes may be made without departing from the scope of the present disclosure. The following detailed description is, therefore, not to be taken in a limiting sense.

Embodiments of the present disclosure present a duplexing network which may be used for coupling separate communications bands and/or providing enhanced isolation between uplink and downlink signal paths. These embodiments provide this improved isolation between uplink and downlink path while allowing the use of ceramic filters in higher power applications. Input/output return loss improvements also provide an advantage when the disclosed duplexing network embodiments are used for combining multiple bands.

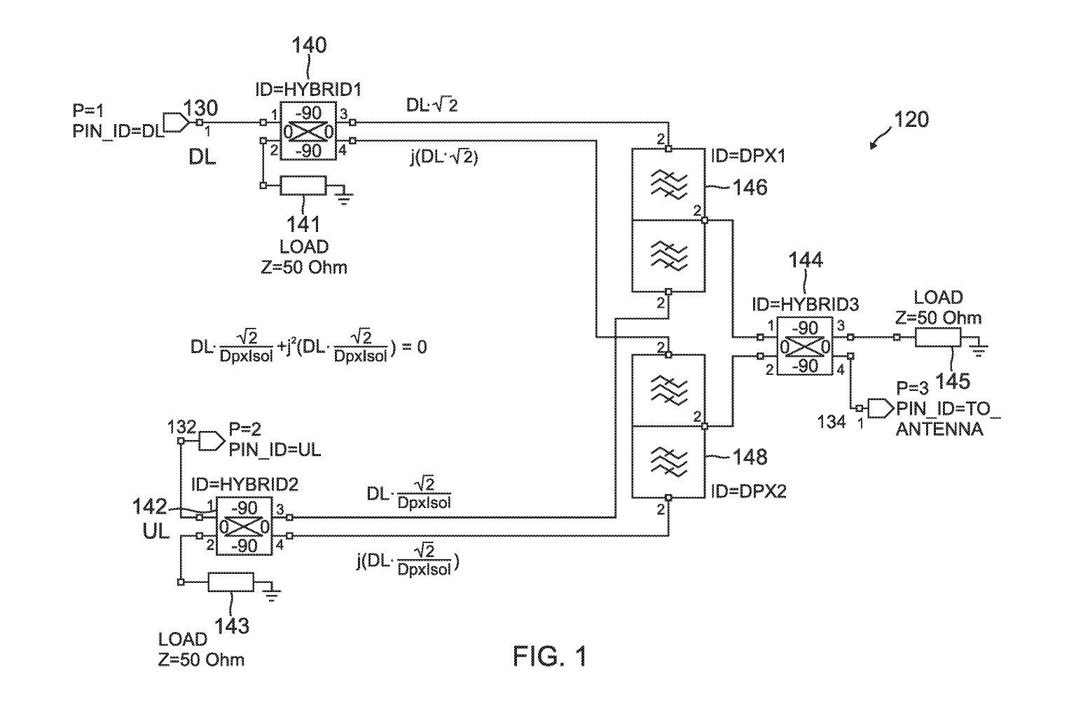

FIG. 1 is a diagram illustrating a duplexing network 120 of one embodiment of the present disclosure. Duplexing network 120 comprises a downlink port 130, an uplink port 132 and an antenna port 134. Duplexing network 120 provides a path for a downlink signal (shown as DL) received at the downlink port 130 to antenna port 134. For example, the downlink port 132 may be coupled to the radio frequency (RF) output port of a power amplifier (PA), in, for example, a remote antenna unit of a distributed antenna system (DAS) or a distributed base station architecture (such as a centralized or cloud radio access network (C-RAN)) or a traditional base station. Duplexing network 120 further provides a path for an uplink signal (shown as UL) received at the antenna port 134 to the uplink port 132. For example, uplink port 132 may be coupled to an input port of a low noise amplifier (LNA), for example, in a remote antenna unit of a DAS or a distributed base station architecture (such as a C-RAN) or a traditional base station. Although port 134 is referred to as antenna port 134, it should be appreciated that this port may be, but is not necessarily, coupled directly to one or more antenna. For example, in other embodiments, such as illustrated below, antenna port 134 for a duplexing network 120 may be coupled to one or more intervening RF splitters, dividers, hybrid couplers, or other RF elements between itself and one or more antennas.

Also, the duplexing network 120 can be used in or with a point of interface (POI) network for a DAS. In such a configuration, the antenna port 134 would be coupled to a duplex port of a base station or off-the-air repeater. Also, in such a configuration, the ports 130 and 132 of the duplexing network 120 are “reversed” in that downlink signals output by the base station or off-the-air repeater are coupled to port 132 of the duplexing network 120 for communicating in the downlink signal path of the POI. Uplink signals received from the uplink signal path of the POI are supplied to port 130 of the duplexing network 120 for communicating to the antenna port 134 of the duplexing network 120 and ultimately to be received by the base station or off-the-air repeater.

Duplexing network 120 further comprises a first hybrid coupler 140, a second hybrid coupler 142, a third hybrid coupler 144, a first duplexer filter 146 and a second duplexer filter 148. Each of the hybrid couplers 140, 142, and 144 shown in FIG. 1 is implemented using a commercially available four-port quadrature hybrid coupler. In the embodiment shown in FIG. 1, each hybrid coupler 140, 142, and 144 includes a first port 1, a second port 2, a third port 3, and a fourth port 4. Each hybrid coupler 140, 142, and 144 is a symmetrical network in that signals applied to any port will be split equally between the two opposite ports such that one half of the input power (−3 dB) will be output on each of the two opposite ports, with the voltages at the two opposite ports being proportional to the square root of two and the signals being output from the two opposite ports being 90 degrees out of phase from each other. For example, in FIG. 1, an input signal applied to port 1 of each hybrid coupler 140, 142, and 144 will be split equally between ports 3 and 4. The signal output at port 3 will be in-phase with the input signal at port 1, and the signal output at port 4 will be shifted by 90 degrees from the input signal at port 1. All reflections are directed to port 2 for hybrid couplers 140 and 142, and directed to port 3 for hybrid coupler 144.

Also, when input signals are applied to two ports on one side of each hybrid coupler 140, 142, and 144, that hybrid coupler 140, 142, and 144 produces a combined output signal at each of the ports on the other side of the coupler. Each of the input signal applied to each of the two input ports will be split equally between the two output ports on the opposite side of the coupler as described above, with the signals output on the two output ports being 90 degrees out of phase from each other. For each of the two output ports, the signals from the two input ports that are provided to that output port are combined. The two combined signals output from each of the output ports are 90 degrees out of phase. For example, in FIG. 1, if input signals applied to ports 3 and 4 of one of the hybrid couplers, each of the input signals will be split equally between ports 1 and 2, with the split signals being 90 degrees out of phase from each other. For each of ports 1 and 2, the signals from input ports 3 and 4 that are provided to that port are combined and will be output from that port, with the signals output on the two ports 1 and 2 being 90 degrees out of phase from each other.

The first hybrid coupler 140 has its first port 1 coupled to the downlink port 130 and its second port 2 coupled to an isolation load 141 (for example, having an impedance of 50 Ohm). The third port 3 of the first hybrid coupler 140 is coupled to a first (or downlink) filter port of the first duplexer filter 146 while the fourth port of the first hybrid coupler 140 is coupled to a first (or downlink) filter port of the second duplexer filter 148. In this configuration, the downlink signal from the downlink port 130 that is supplied to first port 1 of the first hybrid coupler 140 is split and output on the third and fourth ports 3 and 4, with the split signals being equal in magnitude, but phase shifted by 90 degrees. As shown in FIG. 1, for example, the signal output on the third port 3 of the first hybrid coupler 140 can be represented as DL×√2 while the signal output on the fourth port 4 of the first hybrid coupler 140 can be represented as j(DL×√2).

The second hybrid coupler 142 has its first port 1 coupled to the uplink port 132 and its second port 2 is coupled to an isolation load 143 (for example, having an impedance of 50 Ohm). The third port 3 of the second hybrid coupler 142 is coupled to a second (or uplink) filter port of the first duplexer filter 146 while the fourth port 4 of the second hybrid coupler 142 is coupled to a second (or uplink) filter port of the second duplexer filter 148. In this configuration, any uplink signals input on the third and fourth ports 3 and 4 of the second hybrid coupler 142 will be split equally between ports 1 and 2 of the coupler 142, with the split signals being 90 degrees out of phase from each other. For port 1, the signals from input ports 3 and 4 that are provided to that port 1 are 90 degrees out of phase with each other and are combined and output from that port 1.

The third hybrid coupler 144 has its first port 1 coupled to the common filter port of the first duplexer filter 146, its second port 2 coupled to the common filter port of the second duplexer filter 148, its third port 3 coupled to an isolation load 145 (for example, having an impedance of 50 Ohm), and its fourth port 4 coupled to the antenna port 134.

In this configuration, the version of the downlink signal output from the third port 3 of the first hybrid coupler 140 (which is in-phase with the downlink signal at the downlink port 130) is provided as an input to the first port 1 of the third hybrid coupler 144 via the first duplexer filter 146, and the version of the downlink signal output from the fourth port 4 of the first hybrid coupler 140 (which is 90 degrees out of phase with the downlink signal at the downlink port 130) is provided as an input to the second port 2 of the third hybrid coupler 144 via the second duplexer filter 148. The in-phase version of the downlink signal provided as an input to the first port 1 of the third hybrid coupler 144 and the out-of-phase version of the downlink signal provided as an input to the second port 2 of the third hybrid coupler 144 will be combined for output on the fourth port 4 of the third hybrid coupler 144 to the antenna port 134. The in-phase version of the downlink signal provided as an input to the first port 1 of the third hybrid coupler 144 will be phase-shifted by 90 degrees in the third hybrid coupler 144 prior to being combined with the out-of-phase version of the downlink signal provided as an input to the second port 2 of the third hybrid coupler 144. As a result, the two versions of the downlink signals will be constructively combined.

In the uplink direction, in this configuration, an uplink signal received from the antenna port 134 is provided as an input on the fourth port 4 of the third hybrid coupler 144 and will be split within coupler 144 and output from the first and second ports 1 and 2 of the coupler 144. The version of the uplink signal output from the second port 2 of the third hybrid coupler 144 will be in-phase with the uplink signal supplied from the uplink port 134, and the version of the uplink signal output from the first port 1 of the third hybrid coupler 144 will be 90 degrees out of phase with the uplink signal supplied from the uplink port 134. The out-of-phase version of the uplink signal output from the first port 1 of the third hybrid coupler 144 is provided to the third port 3 of the second hybrid coupler 142 via the first duplexer filter 146. The in-phase version of the uplink signal output from the second port 2 of the third hybrid coupler 144 is provided to the fourth port 4 of the second hybrid coupler 142 via the second duplexer filter 148. The out-of-phase version of the uplink signal provided as an input to the third port 3 of the second hybrid coupler 142 and the in-phase version of the uplink signal provided as an input to the fourth port 4 of the second hybrid coupler 142 will be combined for output on the first port 1 of the second hybrid coupler 142 to the uplink port 132. The in-phase version of the uplink signal provided as an input to the fourth port 4 of the second hybrid coupler 142 will be phase-shifted by 90 degrees in the second hybrid coupler 142 prior to being combined with the out-of-phase version of the uplink signal provided as an input to the third port 3 of the second hybrid coupler 142. As a result, the two versions of the uplink signals will be constructively combined.

Because the uplink and downlink signals are each split between the two duplexer filters 146 and 148, they will split the power of the downlink signal between them. Therefore there is a corresponding increase by a factor of two with respect to the RF signal power which can be handled by duplexing network 120 over filter technologies where the entirety of an RF signal flow through a single duplexer filter. As explained below, isolation between the downlink port 130 and the uplink port 132 is also improved.

In one embodiment in operation in the downlink path, the downlink signal DL is received at the downlink port 130 and is split into a first (in-phase) version and a second (quadrature or out-of-phase) version by the first hybrid coupler 140. These two signal versions are equal in magnitude but 90 degrees out of phase with each other. The in-phase signal version is applied to the downlink filter input of the first duplexer 146 while the quadrature phase signal version is applied to the downlink signal input of the second duplexer 148. Following the intended downlink path towards the antenna port 134, the in-phase and quadrature-phase signal versions exit the common ports of duplexer filters 146 and 148, respectively, and are applied to the respective first and second ports 1 and 2 of the third hybrid coupler 144. The in-phase version of the downlink signal provided as an input to the first port 1 of the third hybrid coupler 144 will be phase-shifted by 90 degrees in the third hybrid coupler 144 prior to being combined with the out-of-phase version of the downlink signal provided as an input to the second port 2 of the third hybrid coupler 144. As a result, the two versions of the downlink signals will be constructively combined and the resulting combined signal is output from the fourth port 4 of the coupler 144 to the antenna port 134.

Isolation between the downlink port 130 and uplink port 132 is accomplished, at least in part, through signal cancelation between any part of the in-phase and quadrature versions of the downlink signal that are present at the third and fourth ports 3 and 4, respectively, of the second hybrid coupler 142. That is, some leakage of each of the in-phase and quadrature phase signal versions may occur from the uplink filter ports through to the downlink filter ports of the duplexer filters 146 and 148, and these leakage signals are received at the third and fourth ports 3 and 4 of the second hybrid coupler 142. If these leakage signals are not addressed, they may interfere with operation of receiving electronics coupled to the uplink port 132. Because of the relative phase shift imparted by the first hybrid coupler 140, the leakage downlink signals received at the third and fourth ports 3 and 4 of the hybrid coupler 142 will be out of phase by 90 degrees. The second hybrid coupler 142 imparts an additional 90 degrees of phase separation between the leakage signals so that they destructively sum (that is, cancel each other) when combined within the second hybrid coupler 142. For example, in the embodiment shown in FIG. 1, the leakage quadrature-phase version of the downlink signal present at the fourth port 4 of the second hybrid coupler 142 is shifted a further 90 degrees (for a total of 180 degrees) relative to the leakage in-phase version of the downlink signal present at the third port 3 of the second hybrid coupler 142 before they are combined and output from the first port of the second hybrid coupler 142. The two leakage downlink signals, being equal in magnitude and 180 degrees out of phase, cancel each other such that little-to-no significant portion of the downlink signal DL applied to DL port 130 will leak through to emerge at UL port 132. Given ideal hybrid couplers and perfectly matched duplexers 140 and 142 (meaning that their S-parameters are identical), near perfect cancelation of the DL signal at the uplink port 138 could be expected. However, one of ordinary skill in the art would appreciate that acceptable isolation with negligible leakage may be achieved through careful selection and matching of commercially available components.

In the uplink direction from the antenna port 134 to the uplink port 132, the uplink signal is also separated into in-phase and quadrature-phase versions by the third hybrid coupler 144 and is constructively recombined by the second hybrid coupler 142 prior to being supplied to the uplink port 132. For example, in one embodiment, the uplink signal UL is received at the fourth port 4 of the third hybrid coupler 144 from the antenna port 134 and is split into a first (or in-phase) version and a second (quadrature or out-of-phase) version by the third hybrid coupler 144. These two signal versions are equal in magnitude but 90 degrees out of phase with each other. The quadrature-phase signal version is applied to the common filter port of the first duplexer 146 while the in-phase signal version is applied to the common signal input of the second duplexer 148. Following the intended uplink path towards the uplink port 132, the in-phase and quadrature-phase signal versions exit the uplink filter ports of duplexer filters 148 and 146, respectively, and are applied to the respective third and fourth ports 3 and 4 of the second hybrid coupler 142. The in-phase version of the uplink signal provided as an input to the fourth port 4 of the second hybrid coupler 142 will be phase-shifted by 90 degrees in the second hybrid coupler 142 prior to being combined with the out-of-phase version of the uplink signal provided as an input to the third port 3 of the second hybrid coupler 142. As a result, the two versions of the uplink signals will be constructively combined and the resulting combined signal is output from the first port 1 of the coupler 142 to uplink port 132.

One very beneficial characteristic of duplexing network 120 is that from the perspective of devices coupled to DL port 130, the impedance of duplexing network 120 will appear equivalent to the external load 141 connected to the second port 2 of the first hybrid coupler 140. The Voltage Standing Wave Ratio (VSWR) of duplexing network 120 results in wide band match (to 50 ohms, for example, or some other impedance) due to characteristics of the hybrids even outside of the duplexer 146 and 148 DL pass band. For example, in transmitting electronics using digital pre-distortion where the radio's power amplifier (PA) is robust, this characteristic means that there is no need to add an isolator at the output of the PA. A feedback receiver coupling that is usually provided by a directional coupler will not see the mismatch produce by the transmission path filter. This can result in a wider band suppression of the inter-modulation produce by the PA even without using an isolator.

Referring back to FIG. 1, this means that when duplexer filters 146 and 148 are well matched with respect to their S-parameters, phase, and insertion loss, the wideband return loss observed will be equivalent to the load 145 connected to the third port 3 of the hybrid coupler 144. External devices may therefore be combined with antenna port 134 without an appreciable impedance mismatch. For this reason, multiple duplexing networks such as disclosed by duplexing networks 120 may be combined via their respective antenna ports to provide multiple band duplexers that substantially avoid reflective losses due to impedance mismatch between different the network electronics used for communicating via different bands. Accordingly, embodiments of the present disclosure may provide for quadrature combining networks that can easily accommodate multiple bands without the need for cross-band couplers in case of neighboring bands. For example, a quadrature combining network may be implemented to combine 800 MHz band and a 700 MHz band (or likewise a 1900 MHz band and a 1700/2100 MHz band) without needing a cross-band coupler to avoid impedance mismatch that duplexers would typically cause on the neighboring bands.

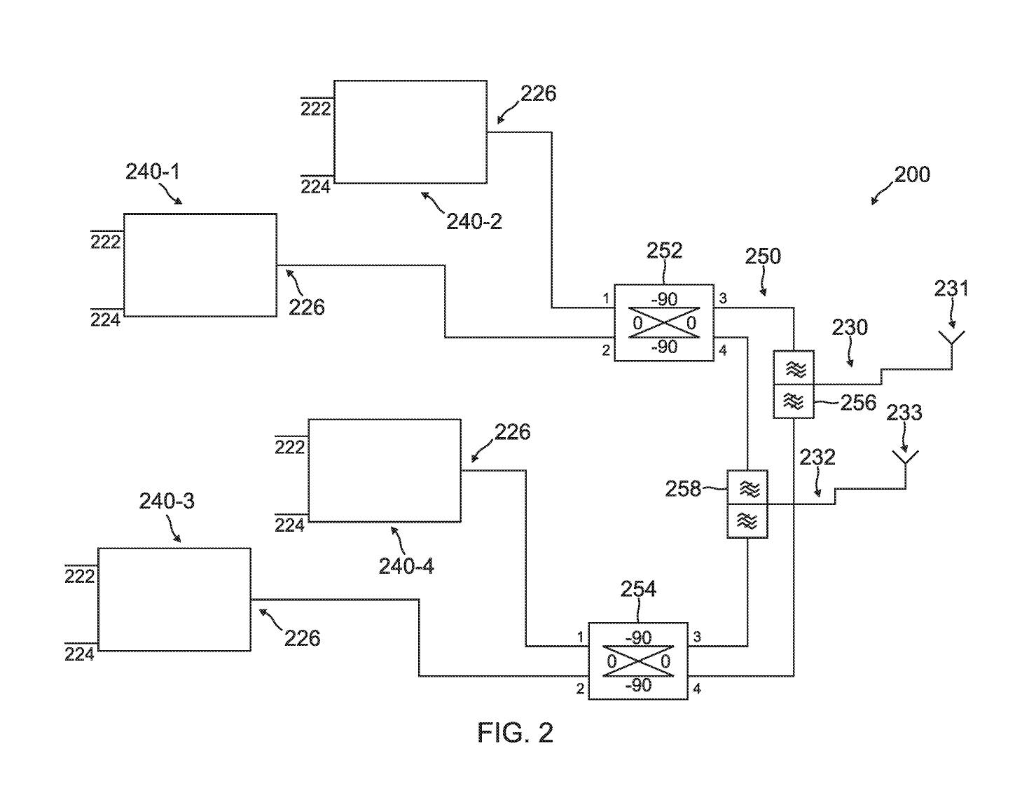

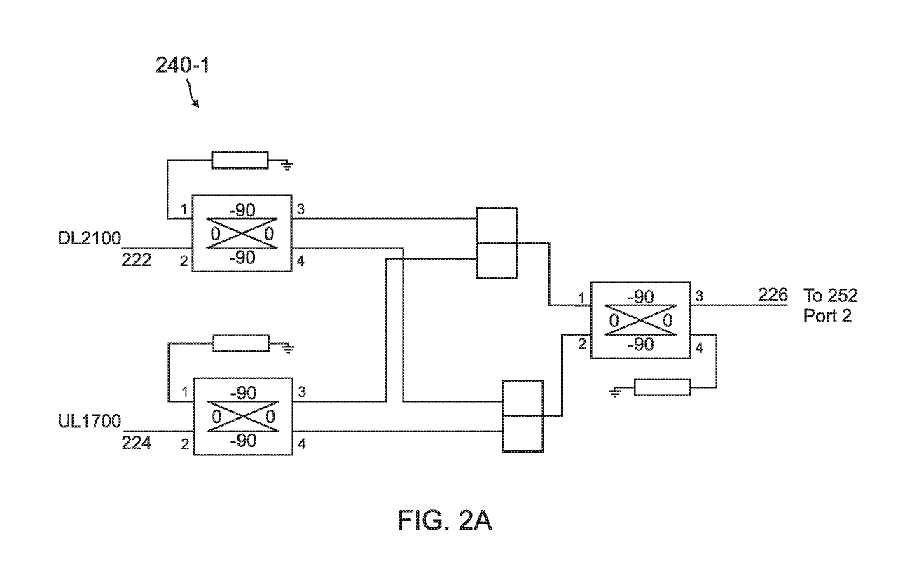

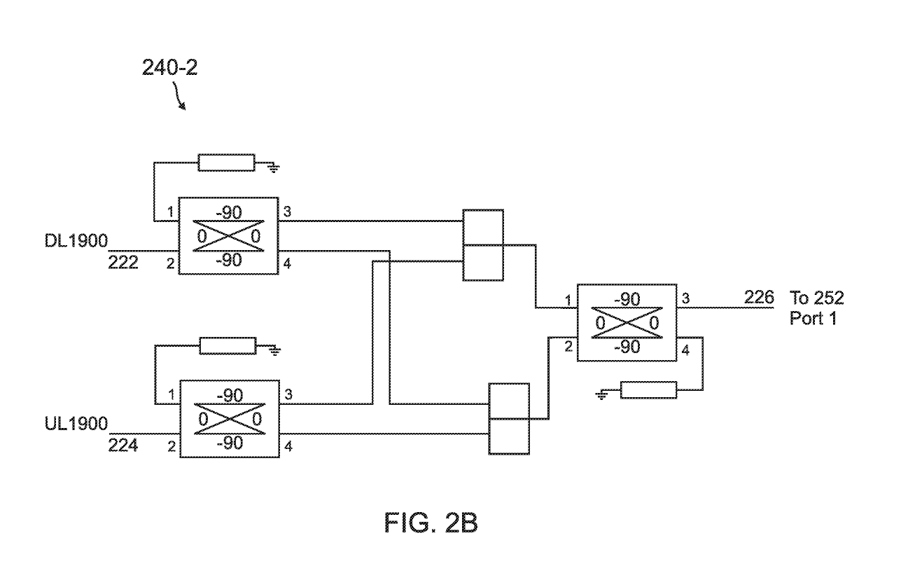

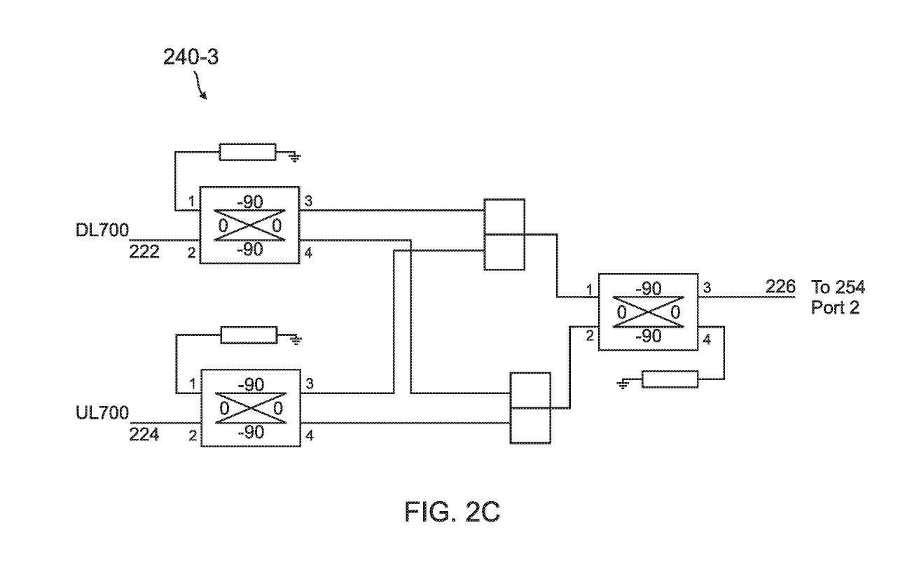

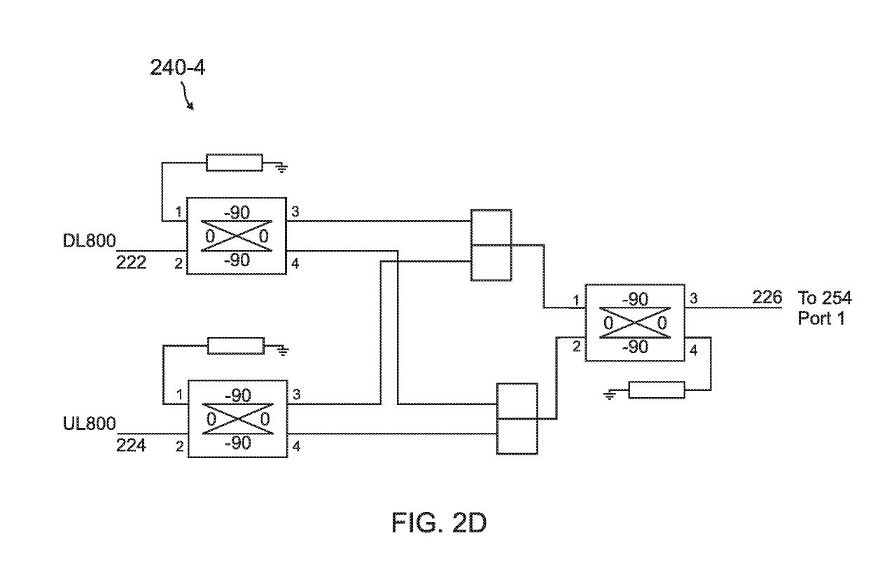

FIG. 2, along with FIG. 2A-2D, is one example of such a quadrature combining network, illustrating a four band quadrature combining network 200 that comprises a combination of four duplexing networks 240 (referenced individually as 240-1, 240-2, 240-3 and 240-4). In one embodiment, each of the duplexing networks 240 shown in FIG. 2 have the same architecture and function as described with respect to the duplexing network 120 shown in FIG. 1 (that is, each duplexing network 240 functions as a duplexer). Each of the duplexing networks 240 is configured to operate over distinct uplink and downlink frequency bands. As such, the functions, structures and description of elements for such embodiments described above may apply to like named elements of network 200 and vice versa.

In quadrature combining network 200, a first set of downlink and uplink frequency bands is handled by duplexing network 240-1, a second set of downlink and uplink frequency bands is handled by duplexing network 240-2, a third set of downlink and uplink frequency bands is handled by duplexing network 240-3, and a fourth set of downlink and uplink frequency bands is handled by duplexing network 240-4. It should be understood that each of four the sets of downlink and uplink frequency bands includes spectrum for transporting both uplink and downlink signals. In the particular embodiments shown in FIG. 2, the upper duplexing networks 240-1 and 240-2 handle signals in high frequency bands (respectively the 1700/2100 MHz and 1900 MHz frequency bands in the embodiment shown in FIG. 2) while the lower two duplexing networks 240-3 and 240-4 handle signals in lower frequency bands (respectively the 700 MHz and 800 MHz frequency bands in the embodiment shown in FIG. 2). However, in other embodiments, other frequency band arrangements may be used. For each of the four duplexing networks 240, isolation between their respective downlink (transmit) and uplink (receive) ports (shown for each network at 222 and 224 respectively) is provided by the duplexing networks 240 as explained above with respect to duplexing network 120 in FIG. 1.

Quadrature combining network 200 is referred to as a combining network because network 200 combines the uplink and downlink signal paths for the four bands with the two antenna ports 230 and 232. The ports 230 and 232 may be coupled respectively to antenna 231 and 233 as shown in FIG. 2. In other embodiments, the ports 230 and 232 may instead be coupled to other electronics.

The fourth port 4 of the third hybrid coupler 144 shown in FIG. 1 is also referred to here as the “antenna port” of the corresponding duplexing network 120. In FIG. 2, the antenna ports 226 of duplexing networks 240 are each coupled to an antenna coupling circuit 250, which is further coupled to the antennas 231 and 233. Specifically the respective antenna ports 226 of duplexing networks 240-1 and 240-2 are coupled to first and second ports 1 and 2, respectively, of a first band combining hybrid 252 (which handles the high frequency bands), and the respective antenna ports 226 of duplexing networks 240-3 and 240-4 are coupled to first and second ports 1 and 2, respectively, of a second band combining hybrid 254 (which handles the low frequency bands). Because of the impedance matching architecture of the duplexing networks 240, the return loss seen at the antenna ports 230 and 232 will not be limited by the duplexer pass bands. Consequently, there will not be a significant degradation of the return loss seen at antenna ports 230 and 232 in the DL and UL bands supported by the duplexing networks 240-1 and 240-2 when combined using combining hybrid 252. The same applies to the DL and UL bands supported by duplexing networks 240-3 and 240-4 when combined using hybrid 254.

For example, the antenna port 226 of both duplexing networks 240-1 and 240-2 are both coupled to the same band combining hybrid 252 so that as long as the impedance of the ports of the hybrid match each other (which for any hybrid fabricated for use for industrial applications they substantially will) then both duplexing networks 240-1 and 240-2 will be impedance matched with the antenna coupling circuit 250. In the same way, the antenna port 226 of both duplexing networks 240-3 and 240-4 are coupled to the same band combining hybrid 254 so that as long as the impedance of the ports of that hybrid match each other, then both duplexing networks 240-3 and 240-4 will be impedance matched with the antenna coupling circuit 250. The benefit of combining two neighboring duplexed bands on two antenna ports in the way describe in FIG. 2 is that there is no need to add a cross band combiner that is lossy and would additionally reduce the transmitter available output power.

The antenna coupling circuit 250, in addition to the first and second band combining hybrids 252 and 254, further comprises diplexers 256 and 258 for combining and splitting the high frequency bands and low frequency bands. In the embodiment shown in FIG. 2, the third port of hybrid 252 is coupled to the first port of diplexer 256 and the fourth port of hybrid 252 is coupled to the first port of diplexer 258. In the downlink path, a first high frequency downlink signal received from duplexing network 240-1 at the second port of the hybrid 252 (that is, the downlink signal in the 2100 MHz frequency band received from the relevant downlink port 222) is split between the third and fourth ports of hybrid 252 with the version of the first high frequency downlink signal provided to the third port shifted in phase by 90 degrees and the version of the first high frequency downlink signal provided to the fourth port shifted in phase by 0 degrees. In the same way, a second high frequency downlink signal received from duplexing network 240-2 at the first port of the hybrid 252 (that is, the downlink signal in the 1900 MHz frequency band received from the relevant downlink port 222) is split between the third and fourth ports of hybrid 252 with the version of the second high frequency downlink signal provided to the third port shifted in phase by 0 degrees and the version of the second high frequency downlink signal provided to the fourth port shifted in phase by 90 degrees.

The version of the first high frequency downlink signal received at the second port of the hybrid 252 that is split and provided to the third port of the hybrid 252 is combined with the version of the second high frequency downlink signal received at the first port of the hybrid 252 that is split and provided to the third port of the hybrid 252. The resulting combined high frequency downlink signals are provided from the third port of the hybrid 252 to the first port of the first diplexer 256. The version of the first high frequency downlink signal received at the second port of the hybrid 252 that is split and provided to the fourth port of the hybrid 252 is combined with the version of the second high frequency downlink signal received at the first port of the hybrid 252 that is split and provided to the fourth port of the hybrid 252. The resulting combined high frequency downlink signals are provided from the fourth port of the hybrid 252 to the first port of the second diplexer 258.

With respect to duplexing networks 240-3 and 240-4, the third port of hybrid 254 is coupled to the second port of diplexer 258 and the fourth port of hybrid coupler 254 is coupled to the second port of diplexer 256. In the downlink path, a first low-frequency downlink signal received from duplexing network 240-3 at the second port of the hybrid 254 (that is, the downlink signal in the 700 MHz frequency band received from the relevant downlink port 222) is split between the third and fourth ports of hybrid 254 with the version of the first low frequency downlink signal provided to the third port shifted in phase by 90 degrees and the version of the first low frequency downlink signal provided to the fourth port shifted in phase by 0 degrees. A second low frequency downlink signal received from duplexing network 240-4 at the first port of the hybrid 254 (that is, the downlink signal in the 800 MHz frequency band received from the relevant downlink port 222) is split between the third and fourth ports of hybrid coupler 254 with the version of the second low frequency downlink signal provided to the third port shifted in phase by 0 degrees and the version of the second low frequency downlink signal provided to the fourth port shifted in phase by 90 degrees.

The version of the first low frequency downlink signal received at the second port of the hybrid 254 that is split and provided to the third port of the hybrid 254 is combined with the version of the second low frequency downlink signal received at the first port of the hybrid 254 that is split and provided to the third port of the hybrid 254. The resulting combined low frequency downlink signals are provided from the third port of the hybrid 254 to the second port of the second diplexer 258. The version of the first low frequency downlink signal received at the second port of the hybrid 254 that is split and provided to the fourth port of the hybrid 254 is combined with the version of the second low frequency downlink signal received at the first port of the hybrid 254 that is split and provided to the fourth port of the hybrid 254. The resulting combined low frequency downlink signals are provided from the fourth port of the hybrid 254 to the second port of the first diplexer 258.

The high frequency and low frequency downlink signal versions received at diplexer 256 are combined and output to antenna 231 via the common port of diplexer 256 via antenna port 230, while the high frequency and low frequency downlink signal versions received at diplexer 258 are combined and output to antenna 233 via the common port of diplexer 258 via antenna port 232.

The upstream path through the antenna coupling circuit 250 for the high and low frequency bands is similar but reversed. Uplink combined high and low frequency signals received via antennas 231 and 233, respectively, are provided, via the antenna ports 230 and 232, to the common ports of diplexers 256 and 258, respectively. Diplexer 256 splits the uplink signal received on its common port from the first antenna 231 into separate high frequency uplink signals and low frequency uplink signals. The high frequency uplink signals are output via the first port of diplexer 256 to the third port of the hybrid 252. The low frequency uplink signals are output from the second port of diplexer 256 to the fourth port of the hybrid 254. Diplexer 258 splits the uplink signal received on its common port from the second antenna 233 into separate high frequency uplink signals and low frequency uplink signals. The high frequency uplink signals are output via the first port of diplexer 258 to the fourth port of the hybrid 252. The low frequency uplink signals are output from the second port of diplexer 258 to the third port of the hybrid 254.

The high frequency uplink signals received from diplexer 256 at the third port of the hybrid 252 are split between the first and second ports of hybrid 252 with the version of the high frequency uplink signals provided to the first port shifted in phase by 0 degrees and the version of the high frequency uplink signals provided to the second port shifted in phase by 90 degrees. The high frequency uplink signals received from diplexer 258 at the fourth port of the hybrid 252 are split between the first and second ports of hybrid 252 with the version of the high frequency uplink signals provided to the first port shifted in phase by 90 degrees and the version of the high frequency uplink signals provided to the second port shifted in phase by 0 degrees. The version of the high frequency uplink signals received at the third port of the hybrid 252 that is split and provided to the first port of the hybrid 252 is combined with the version of the high frequency uplink signals received at the fourth port of the hybrid 252 that is split and provided to the first port of the hybrid 252. The resulting combined high frequency uplink signals are provided from the first port of the hybrid 252 to the antenna port 226 of the second duplexing network 240-2. The second duplexing network 240-2 ultimately provides the uplink signal in the 1900 MHz frequency band to the relevant uplink port 224.

The version of the high frequency uplink signals received at the third port of the hybrid 252 that is split and provided to the second port of the hybrid 252 is combined with the version of the high frequency uplink signals received at the fourth port of the hybrid 254 that is split and provided to the second port of the hybrid 252. The resulting combined high frequency uplink signals are provided from the second port of the hybrid 252 to the antenna port 226 of the first duplexing network 240-1. The first duplexing network 240-1 ultimately provides the uplink signal in the 1700 MHz frequency band to the relevant uplink port 224.

The low frequency uplink signals received from diplexer 256 at the fourth port of the hybrid 254 are split between the first and second ports of hybrid 254 with the version of the low frequency uplink signals provided to the first port shifted in phase by 90 degrees and the version of the low frequency uplink signals provided to the second port shifted in phase by 0 degrees. The low frequency uplink signals received from diplexer 258 at the third port of the hybrid 254 are split between the first and second ports of hybrid 254 with the version of the low frequency uplink signals provided to the first port shifted in phase by 0 degrees and the version of the low frequency uplink signals provided to the second port shifted in phase by 90 degrees. The version of the low frequency uplink signals received at the third port of the hybrid 254 that is split and provided to the first port of the hybrid 254 is combined with the version of the low frequency uplink signals received at the fourth port of the hybrid 254 that is split and provided to the second port of the hybrid 254. The resulting combined low frequency uplink signals are provided from the first port of the hybrid 254 to the antenna port 226 of the fourth duplexing network 240-4. The fourth duplexing network 240-4 ultimately provides the uplink signal in the 800 MHz frequency band to the relevant uplink port 224.

The version of the low frequency uplink signals received at the third port of the hybrid 254 that is split and provided to the second port of the hybrid 254 is combined with the version of the low frequency uplink signals received at the fourth port of the hybrid 254 that is split and provided to the second port of the hybrid 254. The resulting combined low frequency uplink signals are provided from the second port of the hybrid 254 to the antenna port 226 of the third duplexing network 240-3. The third duplexing network 240-3 ultimately provides the uplink signal in the 700 MHz frequency band to the relevant uplink port 224.

The embodiment shown in FIG. 2 illustrates how downstream and upstream signals for four RF bands are combined for sending and receiving using two antenna ports without significant impedance mismatch between the electronics associated with the four RF bands. Further, for each band, isolation between uplink and downlink paths is provided by the respective duplexing network 240 for each band.

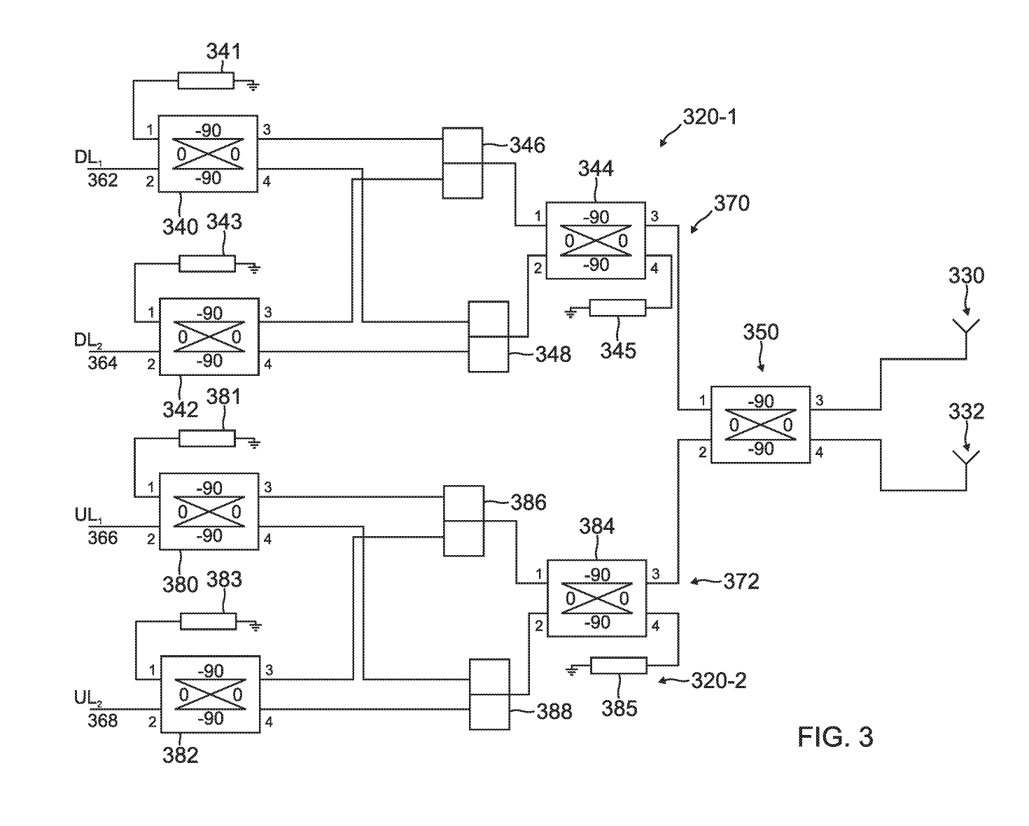

FIG. 3 is a diagram of an alternate quadrature combining network 300 that comprises a combination of two duplexing networks 320 (referenced individually as 320-1, 320-2). In this embodiment, instead of the duplexing networks 320 being utilized as duplexers, they are utilized as diplexers to combine either downlink or uplink signals for two different frequency bands and can also be referred to as “quadrature diplexers 320.” It should be understood that elements of network 300 may be used in conjunction with, in combination with, or substituted for elements of any of the other embodiments described herein. Further, the functions, structures and other description of elements for such embodiments described above may apply to like named elements of network 300 and vice versa.

As shown in FIG. 3, network 300 comprises a first duplexing network 320-1 and a second duplexing network 320-2, both coupled to antenna 330 and 332 via an antenna coupling hybrid 350. The first duplexing network 320-1 includes a first downlink input port 362 and a second downlink input port 364 for receiving first and second downlink signals. The second duplexing network 320-2 includes a first uplink input port 366 and a second uplink output port 368 for outputting first and second uplink signals. An antenna port 370 of the first duplexing network 320-1 is coupled to a first port 1 of the antenna coupling hybrid 350, and an antenna port 372 of the second duplexing network 320-2 is coupled to a second port 2 of the antenna coupling hybrid 350. Because of the impedance matching architecture of the duplexing networks 320, the antenna ports of the duplexing networks 320 can be combined by means of the antenna coupling hybrid 350 the return loss seen at the antenna ports will not be limited by the duplexer pass bands for similar reasons as explained above.

Duplexing network 320-1 further comprises a first hybrid coupler 340, a second hybrid coupler 342, a third hybrid coupler 344, a first diplexer 346 and a second diplexer 348. Each of the hybrid couplers 340, 342, and 344 shown in FIG. 3 is implemented using a standard four-port quadrature hybrid coupler of the type described above in connection with FIG. 1, the description of which is not repeated here for the sake of brevity.

The first hybrid coupler 340 of duplexing network 320-1 has its first port 1 coupled to an isolation load 341 (for example, having an impedance of 50 Ohm) and its second port 2 coupled to the first downlink DL₁ port 362. The third port 3 of the first hybrid coupler 340 is coupled to a first port of the first diplexer 346 while the fourth port of the first hybrid coupler 340 is coupled to a first port of the second diplexer 348. In this configuration, the first downlink signal DL₁ from the downlink port 362 that is supplied to second port 2 of the first hybrid coupler 340 is split and output on the third and fourth ports 3 and 4, with the split signals being equal in magnitude, but phase shifted by 90 degrees. As shown in FIG. 3, for example, the signal output on the third port 3 of the first hybrid coupler 340 can be represented as j(DL₁×√2) while the signal output on the fourth port 4 of the first hybrid coupler 140 can be represented as DL₁√2.

The second hybrid coupler 342 of duplexing network 320-1 has its first port 1 coupled to an isolation load 343 (for example, having an impedance of 50 Ohm) and its second port 2 coupled to the first downlink DL₂ port 364. The third port 3 of the second hybrid coupler 342 is coupled to a second port of the first diplexer 346 while the fourth port of the second hybrid coupler 342 is coupled to a second port of the second diplexer 348. In this configuration, the second downlink signal DL₂ from the downlink port 364 that is supplied to first port 2 of the second hybrid coupler 342 is split and output on the third and fourth ports 3 and 4, with the split signals being equal in magnitude, but phase shifted by 90 degrees. As shown in FIG. 3, for example, the signal output on the third port 3 of the second hybrid coupler 342 can be represented as j (DL₂×√2) while the signal output on the fourth port 4 of the second hybrid coupler 342 can be represented as DL₂×√2.

The third hybrid coupler 344 has its first port 1 coupled to the common filter port of the first diplexer 346, its second port 2 coupled to the common filter port of the second diplexer 348, its third port 3 coupled to the antenna port 370 of duplexing network 320-1 and its fourth port 4 coupled to an isolation load 345 (for example, having an impedance of 50 Ohm).

In this configuration, the version of the first downlink signal DL₁ output from the third port 3 of the first hybrid coupler 340 (which is 90 degrees out of phase with the downlink signal DL₁ at the downlink port 362) is provided as an input to the first port 1 of the third hybrid coupler 344 via the first diplexer 346, and the version of the first downlink signal DL₁ output from the fourth port 4 of the first hybrid coupler 340 (which is 0 degrees out of phase with the first downlink signal DL₁ at the downlink port 362) is provided as an input to the second port 2 of the third hybrid coupler 344 via the second diplexer 348. The 90 degrees out of phase version of the first downlink signal DL₁ provided as an input to the first port 1 of the third hybrid coupler 344 and the in-phase version of the downlink signal provided as an input to the second port 2 of the third hybrid coupler 344 will be combined for output on the third port 3 of the third hybrid coupler 344 to the antenna coupling hybrid 350. The in-phase version of the first downlink signal DL₁ provided as an input to the second port 2 of the third hybrid coupler 344 will be phase-shifted by 90 degrees in the third hybrid coupler 344 prior to being combined with the out-of-phase version of the first downlink signal DL₁ provided as an input to the first port 1 of the third hybrid coupler 344. As a result, the two versions of the downlink signals will be constructively combined at the antenna port 370 output.

Further, the version of the second downlink signal DL₂ output from the third port 3 of the second hybrid coupler 342 (which is 90 degrees out of phase with the downlink signal DL₂ at the downlink port 364) is provided as an input to the first port 1 of the third hybrid coupler 344 via the first diplexer 346, and the version of the second downlink signal DL₂ output from the fourth port 4 of the second hybrid coupler 342 (which is 0 degrees out of phase with the first downlink signal DL₂ at the downlink port 362) is provided as an input to the second port 2 of the third hybrid coupler 344 via the second diplexer 348. The 90 degrees out of phase version of the second downlink signal DL₂ provided as an input to the first port 1 of the third hybrid coupler 344 and the in-phase version of the second downlink signal DL₂ provided as an input to the second port 2 of the third hybrid coupler 344 will be combined for output on the third port 3 of the third hybrid coupler 344 to the antenna coupling hybrid 350. The in-phase version of the second downlink signal DL₂ provided as an input to the second port 2 of the third hybrid coupler 344 will be phase-shifted by 90 degrees in the third hybrid coupler 344 prior to being combined with the out-of-phase version of the second downlink signal DL₂ provided as an input to the first port 1 of the third hybrid coupler 344. As a result, the two versions of the second downlink signal DL₂ will be constructively combined at the antenna port 370 output.

The composite signal received at the first port 1 of the antenna coupling hybrid 350 is therefore the sum of the constructive combination of the first downlink signal DL₁ and the constructive combination of the second downlink signal DL₂. Antenna coupling hybrid 350 is also a standard four-port quadrature hybrid coupler so that signals applied to any port will be split equally between the two opposite ports such that one half of the input power (−3 dB) will be output on each of the two opposite ports, with the voltages at the two opposite ports being proportional to the square root of two and the signals being output from the two opposite ports being 90 degrees out of phase from each other. In the configuration shown in FIG. 3, the composite downlink signal from duplexing network 320-1 that is supplied to first port 1 of the first hybrid coupler 140 is split and output on the third and fourth ports 3 and 4, with the split signals being equal in magnitude, but phase shifted by 90 degrees. As shown in FIG. 3, for example, the in-phase signal output on the third port 3 of the antenna coupling hybrid 350 is output to antenna 330 while the out-of-phase signal output on the fourth port 4 of the antenna coupling hybrid 350 is output to antenna 332.

In the uplink direction, in this configuration, first and second uplink signals UL₁ and UL2 are received from both the antennas 330 and 332 at respective ports 3 and 4 of the antenna coupling hybrid 350. The version of the composite uplink signal output from the second port 2 of the antenna coupling hybrid 350 will comprise a component that is in-phase with the uplink signal supplied from antenna 332, and 90 degrees out of phase with the uplink signal supplied from antenna 330. This version of the composite uplink signal output from the second port 2 of the antenna coupling hybrid 350 is output to the antenna port 372 of duplexing network 320-2.

Duplexing network 320-2 further comprises a fourth hybrid coupler 380, a fifth hybrid coupler 382, a sixth hybrid coupler 384, a third diplexer 386 and a fourth diplexer 388. Each of the hybrid couplers 380, 382, and 384 shown in FIG. 3 is implemented using a standard four-port quadrature hybrid coupler of the type described above in connection with FIG. 1, the description of which is not repeated here for the sake of brevity.

The hybrid coupler 384 has its first port 1 coupled to the common port of diplexer 386, and its second port 2 coupled to the common port of diplexer 388. The third port 3 of hybrid coupler 384 is coupled to the second port of antenna coupling hybrid 350, while the fourth port of the hybrid coupler 384 is coupled to an isolation load 384 (for example, having an impedance of 50 Ohm).

Diplexers 386 and 388 are configured to band pass a frequency band associated with the first uplink signal UL₁ port 366 from their respective first ports while filtering out a frequency band associated with the second uplink UL₂ port 368. As a result, in this configuration, a first version of the first uplink signal UL₁ from diplexer 386 is supplied to third port 3 of the hybrid coupler 380, and a second version of the first uplink signal UL₁ from diplexer 388 (90 degrees out of phase from the first version) is supplied to fourth port 4 of the hybrid coupler 380. The first version of the first uplink signal UL₁, which is phase shifted 90 degrees within hybrid coupler 380, and the second version of the first uplink signal, UL₁ , which is phase shifted 0 degrees within hybrid coupler 380, are constructively combined and output at port 2 of hybrid coupler 380 to the first uplink UL₁ port 366.

Similarly, diplexers 386 and 388 are configured to band pass a frequency band associated with the second uplink signal UL₂ port 368 from their respective second ports while filtering out a frequency band associated with the first uplink UL₁ port 366. As a result, in this configuration, a first version of the second uplink signal UL₂ from diplexer 386 is supplied to third port 3 of the hybrid coupler 380, and a second version of the second uplink signal UL₂ from diplexer 388 (90 degrees out of phase from the first version) is supplied to fourth port 4 of the hybrid coupler 382. The first version of the second uplink signal UL₂, which is phase shifted 90 degrees within hybrid coupler 382, and the second version of the second uplink signal, UL₂, which is phase shifted 0 degrees within hybrid coupler 382, are constructively combined and output at port 2 of hybrid coupler 382 to the second uplink UL₂ port 368.

Because of the impedance matching architecture of the duplexing networks 320, the insertion loss between these antenna ports of the duplexing networks 320 and the antenna coupling hybrid 350 will be the same as explained above. That is, the antenna ports 370 and 372 of duplexing networks 320-1 and 320-2 are coupled to different ports of the same hybrid 350 so that as long as the impedance of the ports of the hybrid match with each other (which for any hybrid fabricated for use for industrial applications they substantially will) then both duplexing networks 320-1 and 320-2 will be combined on the antenna ports 330 and 332 through the hybrid 350, without the need of a cross band combiner that would reduce the overall DL power radiated from the antennas.

Each of the downlink ports 362 and 364 may be coupled to a radio frequency (RF) output port of a respective power amplifier (PA), in, for example, a remote antenna unit of a distributed antenna system (DAS) or a distributed base station architecture (such as a centralized or cloud radio access network (C-RAN)) or a traditional base station. Also, each of the uplink ports 366 and 368 may be coupled to an input port of a respective low noise amplifier (LNA), for example, in a remote antenna unit of a DAS or a distributed base station architecture (such as a C-RAN) or a traditional base station.

It should also be noted that the quadrature combining network 300 can be used in or with a point of interface (POI) network for a DAS. In such a configuration, the antenna coupling hybrid 350 would be coupled to a duplex port of a base station or off-the-air repeater. Also, in such a configuration, the downlink ports 362 and 364 and the uplink ports 366 and 368 would be “reversed” in that downlink signals output by the base station or off-the-air repeater are coupled to ports 366 and 368 for communicating in the downlink signal path of the POI. Uplink signals received from the uplink signal path of the POI would be supplied to ports 362 and 364 for communicating to the antenna coupling hybrid 350 and ultimately to be received by the base station or off-the-air repeater.

In alternate implementations the duplexing networks 120, 240, 320 or a quadrature combining network based on a duplexing network such as shown in any of FIG. 1, 2 or 3) may comprise a component of a wireless network access point (such as a wireless local area network access point), wireless repeater, a cellular radio access network (RAN), a distributed antenna system (DAS) remote antenna unit, or a cellular base station or evolved Node B (for example, a radio point for a cloud or centralized RAN (C-RAN) architecture system).

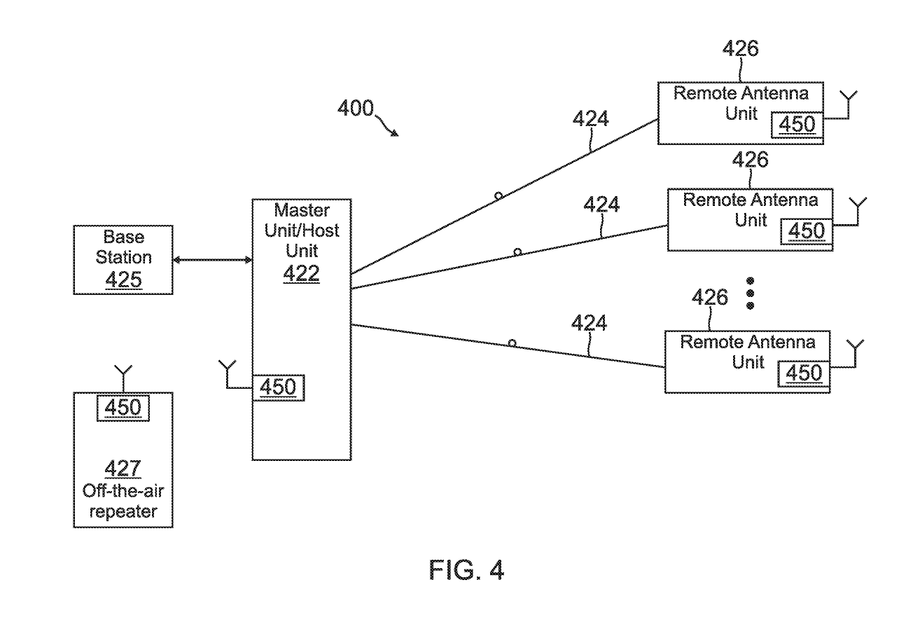

As an example, FIG. 400 is a block diagram that illustrates a distributed antenna system at 400 of one embodiment of the present disclosure. DAS 400 comprises a master unit (or host unit) 422 coupled to a plurality of remote antenna units (shown at 426) by a plurality of digital transport links 424. Remote antenna units 426 may be directly coupled to a host unit 422 or indirectly coupled to host unit 422 via one or more intervening devices. Digital transport links 424 may comprise fiber optic links as shown in FIG. 4, but in other implementation may comprise other materials such as but not limited to copper wires.

In the downlink direction, DAS 400 operates as a point-to-multipoint transport for RF signals. Downlink signals received by DAS 400 at host unit 422 (for example, from at least one base station (BS) 425 and/or off-the-air repeater 427) are simultaneously transported to each of the remote antenna units 426. In the uplink direction, RF signals collected at each of the remote antenna units 426 are transported to the host unit 422, where the RF signals are aggregated to provide a unified RF signal to further upstream components. Alternate example architectures for DAS 500 are disclosed by U.S. patent Application Ser. No. 13/495,220, filed on Jun. 13, 2013, and titled “Distributed Antenna System Architectures” which is incorporated herein by reference in its entirety.

In some embodiments, the base stations 425 and/or repeaters 427 can be coupled to the master unit 422 using a network of attenuators, combiners, splitters, amplifiers, filters, cross-connects, etc., (sometimes referred to collectively as a “point-of-interface” or “POI”). This is done so that, in the downstream, the desired set of RF carriers output by the base stations 425 or repeaters 427 can be extracted, combined, and routed to the appropriate master unit 422, and so that, in the upstream, the desired set of carriers output by the master unit 422 can be extracted, combined, and routed to the appropriate interface of each base station 425 or repeater 427. The network that is used to couple the base stations 425 and/or repeaters 427 to the ports of the master unit 422 may include additional stages for routing, splitting, and combing stages signals (including, for example, sector matrix stages and/or zone combiner stages).

One or more of the remote antenna units 426, off-the-air repeaters 427 or host/master unit 422, may include or be coupled to one or more duplexing networks 450 or a quadrature combining network based on a duplexing network such as shown in any of FIG. 1, 2 or 3) in order to couple radio electronics to one or more antenna.

For example, the in the remote antenna units, one or more duplexing networks 450 (or a quadrature combining network based on a duplexing network) may couple radio electronics in the remote antenna units 426 to one or more antenna for wirelessly transmitting downlink RF signals and receiving uplink RF signals.

Also, a duplexing network 450 (or a quadrature combining network based on a duplexing network) can be used in or with a POI network used in a DAS 400. As noted above, in such a configuration, the antenna port of the duplexing networks 450 would be coupled to a duplex port of a base station 425 or off-the-air repeater 427. Also, in such a configuration, the uplink and downlink ports of the quadrature duplexer would be “reversed” from those shown with respect to duplexing network 120 in that downlink signals output by the base station or off-the-air repeater are coupled to port 132 of the duplexing network 120 for communicating in the downlink signal path of the POI. Uplink signals received from the uplink signal path of the POI are supplied to port 130 of the duplexing network 120 for communicating to the antenna port 134 of the duplexing network 120 and ultimately to be received by the base station 425 or off-the-air repeater 427.

Such embodiments may be utilized to facilitate isolation between upstream and downstream signal paths, provide impedance matching to reduce insertion losses when combining different RF bands, or both. It should also be understood that although the duplexing networks 450 are shown as being part of the radio antenna unit 426, in some embodiments, they may be a separate element from the radio antenna unit 426.

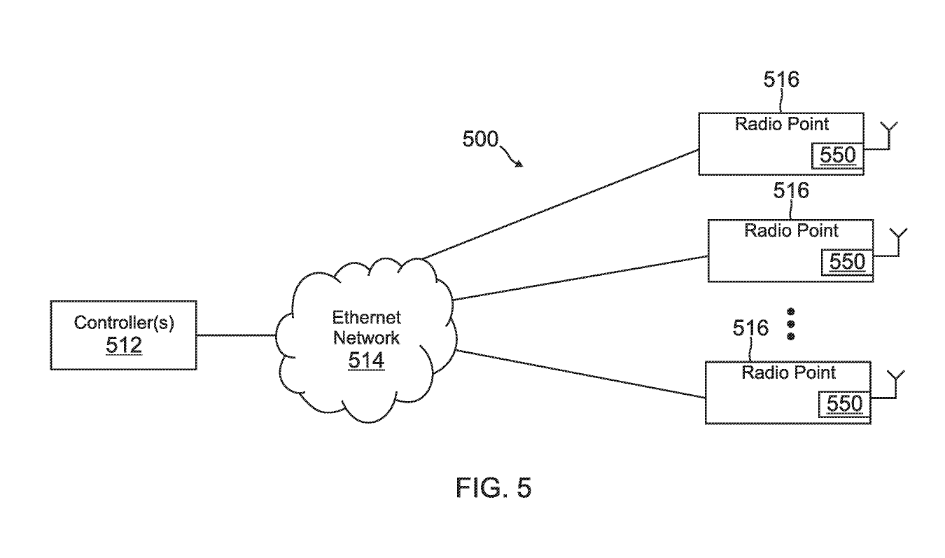

FIG. 5 is a block diagram that illustrates a C-RAN at 500 of one embodiment of the present disclosure. In this embodiment, one or more controllers 512 are coupled to a plurality of radio points 516 over an Ethernet network 514. In one implementation of C-RAN 500, the Ethernet network 514 is implemented over copper wiring and may further comprise one or more Ethernet switches coupled by the copper wiring. In other implementations, other transport media may be used such as but not limited to fiber optic cables. Alternate example architectures for C-RAN 400 are disclosed by U.S. patent application Ser. No. 13/762,283, filed on Feb. 7, 2013, and titled “RADIO ACCESS NETWORKS” which is incorporated herein by reference in its entirety. One or more of the radio points 516 may comprise one or more duplexing networks 550 or a quadrature combining network based on a duplexing network (such as shown in FIG. 1, 2 or 3) to couple radio electronics in the radio point to one or more antenna. Such embodiments may be utilized to facilitate isolation between upstream and downstream signal paths, provide impedance matching to reduce insertion losses when combining different RF bands, or both. It should also be understood that although the duplexing networks 550 are shown as being part of the radio point 516, in some embodiments, they may be a separate element from the radio point 516.

### EXAMPLE EMBODIMENTS

Example 1 includes a duplexing network for isolating two signals, the network comprising: a first port; a second port; a third port; a first hybrid coupler coupled to the first port; a second hybrid coupler coupled to the second port; a third hybrid coupler coupled to the third port; wherein the first hybrid coupler, the second hybrid coupler and the third hybrid coupler are each four-port quadrature hybrid couplers; wherein the first hybrid splits a first signal received at the first port between a first signal component output to a first duplexer and a second signal component output to a second duplexer; wherein the third hybrid receives the first signal component from the first duplexer and the second signal component from the second duplexer and constructively sums the first signal component and the second signal component to produce an output at the third port; wherein the second hybrid receives a first leakage signal from the first signal component leaking through first duplexer and second leakage signal from the second signal component leaking through second duplexer and destructively sums the first leakage signal and the second leakage signal prior to the second port.

Example 2 includes the network of example 1, wherein the first signal received at the first port is a downlink signal, the second port is an uplink port and the third port is an antenna port.

Example 3 includes the network of any of examples 1-2, wherein the first signal received at the first port is an uplink signal, the second port is a downlink port and the third port is an antenna port.

Example 4 includes a duplexing network for combining two signals, the network comprising: a first port; a second port; a third port; a first hybrid coupler coupled to the first port; a second hybrid coupler coupled to the second port; a third hybrid coupler coupled to the third port; wherein the first hybrid coupler, the second hybrid coupler and the third hybrid coupler are each four-port quadrature hybrid couplers; wherein the first hybrid splits a first signal received at the first port between a first diplexer and a second diplexer; wherein the second hybrid splits a second signal received at the first port between the first diplexer and the second diplexer; wherein the third hybrid receives a first composite signal from the first diplexer and a second composite signal from the second diplexer and constructively sums the first composite signal and the second composite signal to produce an output at the third port.

Example 5 includes a duplexing network for splitting two signals, the network comprising: a first port; a second port; a third port; a first hybrid coupler coupled to the first port; a second hybrid coupler coupled to the second port; a third hybrid coupler coupled to the third port; wherein the first hybrid coupler, the second hybrid coupler and the third hybrid coupler are each four-port quadrature hybrid couplers; wherein the third hybrid splits a first signal received at the third port between a first diplexer and a second diplexer; wherein the first hybrid receives a first composite signal from the first diplexer and a second composite signal from the second diplexer and constructively sums the first composite signal and the second composite signal to produce an output at the first port; and wherein the second hybrid receives a third composite signal from the first diplexer and a fourth composite signal from the second diplexer and constructively sums the third composite signal and the fourth composite signal to produce an output at the second port.

Example 6 includes a duplexing network, the duplexing network comprising: a first hybrid coupler; a second hybrid coupler; a third hybrid coupler; a first duplexer filter; and a second duplexer filter; wherein the first hybrid coupler, the second hybrid coupler and the third hybrid coupler are each four-port quadrature hybrid couplers; wherein a first port of the first hybrid coupler is coupled to a first radio frequency signal port of the duplexing network and a first port of the second hybrid coupler is coupled to a second radio frequency signal port of the duplexing network; wherein a second port of the first hybrid coupler is coupled to a first isolation impedance and a second port of the second hybrid coupler is coupled to a second isolation impedance; and where a third port of the first hybrid coupler is coupled to a first filter port of the first duplexer filter, and a fourth port of the first hybrid coupler is coupled to a first filter port of the second duplexer filter; wherein a third port of the second hybrid coupler is coupled to a second filter port of the first duplexer, and a fourth port of the second hybrid coupler is coupled to a second filter port of the second duplexer; wherein a common filter port of the first duplexer is coupled to a first port of the third hybrid coupler and a common filter port of the second duplexer is coupled to a second port of the third hybrid coupler; wherein a third port of the third hybrid coupler is coupled to a third isolation impedance and a fourth port of the third hybrid coupler is coupled to an antenna port of the quadrature duplexer.

Example 7 includes the duplexing network of example 6, wherein the first hybrid coupler and the second hybrid coupler are each configured to apply a 90 degree phase shift that when summed results in a destructive summation of a first leakage signal and a second leakage signal by the second hybrid coupler, wherein the first leakage signal results from leakage from the first filter port of the first duplexer filter to the second filter port of the first duplexer filter, and the second leakage signal results from leakage from the first filter port of the second duplexer filter to the second filter port of the second duplexer filter.

Example 8 includes the duplexing network of any of examples 6-7, wherein the first hybrid coupler and the third hybrid coupler are each configured to apply a 90 degree phase shift that when summed result in a constructive summation by the third hybrid coupler of a first signal received from the common filter port of the first duplex filter and a second signal received from the common filter port of the second duplex filter.

Example 9 includes the duplexing network of any of examples 6-8, wherein the first radio frequency signal port is a downlink signal input port, the second radio frequency signal port is an uplink signal output port, and the third radio frequency signal port is an antenna port.

Example 10 includes the duplexing network of example 9, wherein the third radio frequency signal port is coupled to a first port of a first band combining hybrid, wherein a second antenna port of a second duplexing network is coupled to a second port of the first band combining hybrid.

Example 11 includes the duplexing network of any of examples 6-8, wherein the first radio frequency signal port is a first downlink signal input port, the second radio frequency signal port is a second downlink signal input port, and the third radio frequency signal port is an antenna port.

Example 12 includes the duplexing network of any of example 11, wherein the third radio frequency signal port is coupled to a first port of an antenna coupling hybrid, wherein a second antenna port of a second duplexing network is coupled to a second port of the antenna coupling hybrid.

Example 13 includes the duplexing network of any of examples 6-8, wherein the first radio frequency signal port is a first uplink signal output port, the second radio frequency signal port is a second uplink signal output port, and the third radio frequency signal port is an antenna port.

Example 14 includes the duplexing network of example 13, wherein the third radio frequency signal port is coupled to a first port of an antenna coupling hybrid, wherein a second antenna port of a second duplexing network is coupled to a second port of an antenna coupling hybrid.

Example 15 includes a duplexing network, the duplexing network comprising: a downlink signal path between a downlink port and an antenna port, wherein the downlink signal path is configured to split a downlink signal into an in-phase downlink signal component and a quadrature phase downlink signal component; and an uplink signal path between the antenna port and an uplink port, wherein the uplink signal path is configured to apply a further 90 degree phase shift between a first leakage signal from the in-phase downlink signal component and a second leakage signal from the quadrature phase downlink signal component that destructively sums the first leakage signal with the second leakage signal prior to the uplink port.

Example 16 includes the network of example 15, wherein the downlink signal path is further configured to shift the relative phases of the in-phase downlink signal component and the quadrature phase downlink signal component by 90 degrees to constructively recombine the in-phase downlink signal component and the quadrature phase downlink signal component prior to the antenna port.

Example 17 includes the duplexing network of any of examples 15-16, wherein the downlink port is coupled to a radio frequency transmitter and the uplink port is coupled to a radio frequency receiver.

Example 18 includes the duplexing network of any of examples 15-17, wherein the antenna port is coupled to one or more antenna.

Example 19 includes the duplexing network of example 18, wherein the antenna port is coupled to the one or more antenna via an antenna coupling circuit.

Example 20 includes the duplexing network of example 19, wherein at least a second duplexing network is also coupled to the one or more antenna via the antenna coupling circuit.

Example 21 includes the duplexing network of any of examples 15-20, wherein the downlink signal path comprises a first hybrid coupler that splits the downlink signal into the in-phase downlink signal component and the quadrature phase downlink signal component.

Example 22includes the duplexing network of example 21, wherein the uplink signal path comprises a second hybrid coupler that applies the further 90 degree phase shift between the first leakage signal and the second leakage signal that destructively sums the first and second leakage signals prior to the uplink port.

Example 23 includes the duplexing network of example 22, wherein the downlink signal path comprises a third hybrid coupler configured to shift the relative phases of the in-phase downlink signal component and the quadrature phase downlink signal component by 90 degrees to constructively recombine the in-phase downlink signal component and the quadrature phase downlink signal component prior to the antenna port.

Example 24 includes the duplexing network of example 23, further comprising: a first duplexer filter; and a second duplexer filter; wherein the first hybrid coupler couples the in-phase downlink signal component through the first duplexer filter prior to the antenna port and couples the quadrature phase downlink signal component through the second duplexer filter prior to the antenna port.

Example 25 includes the duplexing network of example 24, wherein second hybrid coupler is coupled to the first duplexer filter and the second duplexer filter.

Example 26 includes a frequency band combining network, the network comprising at least one duplexing network as described in any of claims 1-25.

Example 27 includes a wireless network access point comprising at least one duplexing network as described in any of claims 1-25.

Example 28 includes a radio point for a cloud RAN architecture system comprising at least one duplexing network as described in any of claims 1-25.

Example 29 includes a cellular radio access network (RAN) system comprising at least one duplexing network as described in any of claims 1-25.

Example 30 includes a distributed antenna system, the system comprising at least one duplexing network as described in any of claims 1-25.

Example 31 includes the system of example 30, the system further comprising a plurality of remote antenna units coupled to a host unit, wherein one or more of the remote antenna units comprise at least one duplexing network as described in any of claims 1-25.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A duplexing network for isolating two signals, the network comprising:
a first port;
a second port;
a third port;
a first hybrid coupler coupled to the first port;
a second hybrid coupler coupled to the second port;
a third hybrid coupler coupled to the third port;
wherein the first hybrid coupler, the second hybrid coupler and the third hybrid coupler are each four-port quadrature hybrid couplers;
wherein the first hybrid splits a first signal received at the first port between a first signal component output to a first duplexer and a second signal component output to a second duplexer;
wherein the third hybrid receives the first signal component from the first duplexer and the second signal component from the second duplexer and constructively sums the first signal component and the second signal component to produce an output at the third port;
wherein the second hybrid receives a first leakage signal from the first signal component leaking through the first duplexer and second leakage signal from the second signal component leaking through the second duplexer and destructively sums the first leakage signal and the second leakage signal prior to the second port.

2. The network of claim 1, wherein the first signal received at the first port is a downlink signal, the second port is an uplink port and the third port is an antenna port.

3. The network of claim 1, wherein the first signal received at the first port is an uplink signal, the second port is a downlink port and the third port is an antenna port.

4. A duplexing network for combining two signals, the network comprising:
a first port;
a second port;
a third port;
a first hybrid coupler coupled to the first port;
a second hybrid coupler coupled to the second port;
a third hybrid coupler coupled to the third port;
wherein the first hybrid coupler, the second hybrid coupler and the third hybrid coupler are each four-port quadrature hybrid couplers;
wherein the first hybrid splits a first signal received at the first port between a first diplexer and a second diplexer;
wherein the second hybrid splits a second signal received at the first port between the first diplexer and the second diplexer;
wherein the third hybrid receives a first composite signal from the first diplexer and a second composite signal from the second diplexer and constructively sums the first composite signal and the second composite signal to produce an output at the third port.

5. A duplexing network for splitting two signals, the network comprising:
a first port;
a second port;
a third port;
a first hybrid coupler coupled to the first port;
a second hybrid coupler coupled to the second port;
a third hybrid coupler coupled to the third port;
wherein the first hybrid coupler, the second hybrid coupler and the third hybrid coupler are each four-port quadrature hybrid couplers;
wherein the third hybrid splits a first signal received at the third port between a first diplexer and a second diplexer;
wherein the first hybrid receives a first composite signal from the first diplexer and a second composite signal from the second diplexer and constructively sums the first composite signal and the second composite signal to produce an output at the first port; and
wherein the second hybrid receives a third composite signal from the first diplexer and a fourth composite signal from the second diplexer and constructively sums the third composite signal and the fourth composite signal to produce an output at the second port.

6. A duplexing network, the duplexing network comprising:
a first hybrid coupler;
a second hybrid coupler;
a third hybrid coupler;
a first duplexer filter; and
a second duplexer filter;
wherein the first hybrid coupler, the second hybrid coupler and the third hybrid coupler are each four-port quadrature hybrid couplers;
wherein a first port of the first hybrid coupler is coupled to a first radio frequency signal port of the duplexing network and a first port of the second hybrid coupler is coupled to a second radio frequency signal port of the duplexing network;
wherein a second port of the first hybrid coupler is coupled to a first isolation impedance and a second port of the second hybrid coupler is coupled to a second isolation impedance; and
where a third port of the first hybrid coupler is coupled to a first filter port of the first duplexer filter, and a fourth port of the first hybrid coupler is coupled to a first filter port of the second duplexer filter;
wherein a third port of the second hybrid coupler is coupled to a second filter port of the first duplexer, and a fourth port of the second hybrid coupler is coupled to a second filter port of the second duplexer;
wherein a common filter port of the first duplexer is coupled to a first port of the third hybrid coupler and a common filter port of the second duplexer is coupled to a second port of the third hybrid coupler;
wherein a third port of the third hybrid coupler is coupled to a third isolation impedance and a fourth port of the third hybrid coupler is coupled to an antenna port of the quadrature duplexer.

7. The duplexing network of claim 6, wherein the first hybrid coupler and the second hybrid coupler are each configured to apply a 90 degree phase shift that when summed results in a destructive summation of a first leakage signal and a second leakage signal by the second hybrid coupler, wherein the first leakage signal results from leakage from the first filter port of the first duplexer filter to the second filter port of the first duplexer filter, and the second leakage signal results from leakage from the first filter port of the second duplexer filter to the second filter port of the second duplexer filter.

8. The duplexing network of claim 6, wherein the first hybrid coupler and the third hybrid coupler are each configured to apply a 90 degree phase shift that when summed result in a constructive summation by the third hybrid coupler of a first signal received from the common filter port of the first duplex filter and a second signal received from the common filter port of the second duplex filter.

9. The duplexing network of claim 6, wherein the first radio frequency signal port is a downlink signal input port, the second radio frequency signal port is an uplink signal output port, and the third radio frequency signal port is an antenna port.

10. The duplexing network of claim 9, wherein the third radio frequency signal port is coupled to a first port of a first band combining hybrid, wherein a second antenna port of a second duplexing network is coupled to a second port of the first band combining hybrid.

11. The duplexing network of claim 6, wherein the first radio frequency signal port is a first downlink signal input port, the second radio frequency signal port is a second downlink signal input port, and the third radio frequency signal port is an antenna port.

12. The duplexing network of claim 11, wherein the third radio frequency signal port is coupled to a first port of an antenna coupling hybrid, wherein a second antenna port of a second duplexing network is coupled to a second port of the antenna coupling hybrid.

13. The duplexing network of claim 6, wherein the first radio frequency signal port is a first uplink signal output port, the second radio frequency signal port is a second uplink signal output port, and the third radio frequency signal port is an antenna port.

14. The duplexing network of claim 13, wherein the third radio frequency signal port is coupled to a first port of an antenna coupling hybrid, wherein a second antenna port of a second duplexing network is coupled to a second port of an antenna coupling hybrid.

15. A duplexing network, the duplexing network comprising:
a downlink signal path between a downlink port and an antenna port, wherein the downlink signal path is configured to split a downlink signal into an in-phase downlink signal component and a quadrature phase downlink signal component; and
an uplink signal path between the antenna port and an uplink port, wherein the uplink signal path is configured to apply a further 90 degree phase shift between a first leakage signal from the in-phase downlink signal component and a second leakage signal from the quadrature phase downlink signal component that destructively sums the first leakage signal with the second leakage signal prior to the uplink port.

16. The network of claim 15, wherein the downlink signal path is further configured to shift the relative phases of the in-phase downlink signal component and the quadrature phase downlink signal component by 90 degrees to constructively recombine the in-phase downlink signal component and the quadrature phase downlink signal component prior to the antenna port.

17. The duplexing network of claim 15, wherein the downlink port is coupled to a radio frequency transmitter and the uplink port is coupled to a radio frequency receiver.

18. The duplexing network of claim 15, wherein the antenna port is coupled to one or more antenna.

19. The duplexing network of claim 18, wherein the antenna port is coupled to the one or more antenna via an antenna coupling circuit.

20. The duplexing network of claim 19, wherein at least a second duplexing network is also coupled to the one or more antenna via the antenna coupling circuit.

21. The duplexing network of claim 15, wherein the downlink signal path comprises a first hybrid coupler that splits the downlink signal into the in-phase downlink signal component and the quadrature phase downlink signal component.

22. The duplexing network of claim 21, wherein the uplink signal path comprises a second hybrid coupler that applies the further 90 degree phase shift between the first leakage signal and the second leakage signal that destructively sums the first and second leakage signals prior to the uplink port.

23. The duplexing network of claim 22, wherein the downlink signal path comprises a third hybrid coupler configured to shift the relative phases of the in-phase downlink signal component and the quadrature phase downlink signal component by 90 degrees to constructively recombine the in-phase downlink signal component and the quadrature phase downlink signal component prior to the antenna port.

24. The duplexing network of claim 23, further comprising:
a first duplexer filter; and
a second duplexer filter;
wherein the first hybrid coupler couples the in-phase downlink signal component through the first duplexer filter prior to the antenna port and couples the quadrature phase downlink signal component through the second duplexer filter prior to the antenna port.

25. The duplexing network of claim 24, wherein second hybrid coupler is coupled to the first duplexer filter and the second duplexer filter.

26. The network of claim 1, wherein at least one of the first duplexer and the second duplexer comprise a ceramic filter.

27. The network of claim 4, wherein at least one of the first duplexer and the second duplexer comprise a ceramic filter.

28. The network of claim 5, wherein at least one of the first duplexer and the second duplexer comprise a ceramic filter.

29. The network of claim 6, wherein at least one of the first duplexer filter and the second duplexer filter comprise a ceramic filter.

30. The network of claim 24, wherein at least one of the first duplexer filter and the second duplexer filter comprise a ceramic filter.
